(19) United States
(12) Patent Application Publication
(10) Pub. No.: US 2007/0219790 A1
(43) Pub. Date: Sep. 20, 2007

(54) METHOD AND SYSTEM FOR SOUND SYNTHESIS

(75) Inventor: Werner Verhelst, Strombeek-Bever (BE)

Correspondence Address: KNOBBE MARTENS OLSON & BEAR LLP, 2040 MAIN STREET, FOURTEENTH FLOOR, IRVINE, CA, 92614, US

(73) Assignee: VRIJE UNIVERSITEIT BRUSSEL, Brussels (BE)

(21) Appl. No.: 11/676,504

(22) Filed: Feb. 19, 2007

Related U.S. Application Data
(63) Continuation of application No. PCT/BE05/00130, filed on Aug. 19, 2005.

(30) Foreign Application Priority Data
Aug. 19, 2004 (EP) 04447190.2

(51) Int. Cl. G10L 19/00

(52) U.S. Cl. 704/220

(57) ABSTRACT

A method and system for synthesizing an audio (equivalent) signal with a desired perceived pitch P″ is disclosed. A train of pulses with relative spacing P and impulse responses h seen by the train of pulses is determined, yielding an audio (equivalent) signal with actual perceived pitch P′. Information related to the difference between the desired perceived pitch P″ and the actual perceived pitch P′ is determined. The audio (equivalent) signal is corrected for the difference between P″ and P′, thereby making use of the information and yielding the audio (equivalent) signal with desired perceived pitch P″.

### RELATED APPLICATIONS

This is a continuation application under 35 U.S.C. § 120 of WO 2006/017916 A1, filed as PCT/BE2005/000130 on Aug. 19, 2005, which is hereby incorporated by reference.

### FIELD OF THE INVENTION

The present invention is related to techniques for the modification and synthesis of speech and other audio equivalent signals and, more particularly, to those based on the source-filter model of speech production.

### STATE OF THE TECHNOLOGY

The pitch synchronized overlap-add (PSOLA) strategy is well known in the field of speech synthesis for the natural sound and low complexity of the method, e.g., in ‘Pitch-Synchronous Waveform Processing Techniques for Text-to-Speech Synthesis Using Diphones’, E. Moulines, F. Charpentier, Speech Communication, vol. 9, pp. 453-467, 1990. It was disclosed in one of its forms in patent EP-B-0363233. In fact, it was shown in ‘On the Quality of Speech Produced by Impulse Driven Linear Systems’, W. Verhelst, IEEE proceedings of ICASSP-91, pp. 501-504, Toronto, May 14-17, 1991, that pitch synchronized overlap-add methods operate as a specific case of an impulse driven (in the field of speech synthesis often termed pitch-excited) linear synthesis system, in which the input pitch impulses coincide with the pitch marks of PSOLA and the system's impulse responses are the PSOLA synthesis segments.

A pitch-excited source filter synthesis system is shown in FIG. 1a, where the source component 1010 i(n) generates a vocal source signal in the form of a pulse train, and linear system 1020 is characterized by its time-varying impulse response h(n;m). Typical examples of a voice source signal and an impulse response are illustrated in FIGS. 1b and 1c, respectively. Speech modification and synthesis techniques that are based on the source-filter model of speech production are characterized in that the speech signal is constructed as the convolution of a voice source signal with a time-varying impulse response, as shown in equation 1.

$$s ( n ) = {\sum }_{m = - ∞}^{+ ∞} i ( m ) h ( n ; m ) \qquad ( equation 1 )$$

FIG. 2 illustrates how in a typical PSOLA procedure, the voice source signal 2010 is constructed as an impulse train 2020 with impulses located at the positive going zero crossings 2030 at the beginning of each consecutive pitch period, and how the time-varying impulse response 2050 is characterized by windowed segments 2060 from the analyzed speech signal 2070.

Another method called PIOLA (‘Pitch inflected overlap and add speech manipulation’) was disclosed in European patent EP-B-0527529. It operates in a similar manner, except that the pitch marks are positioned relative to one another at a distance of one pitch period, as obtained from a pitch detection algorithm.

In the conventional operation of source-filter models, pulses in the source signal i(n) of equation 1 are spaced apart in time with a distance equal to the inverse of the pitch frequency that is desired for the synthesized sound s(n). It is known that the perceived pitch will then approximate the desired pitch in the case of wide-band periodic sounds (e.g., those that are produced according to equation 1 with constant distance between pitch marks and constant shape of the impulse responses). However, in natural speech used in speech synthesis and modification methods, the shape of the impulse responses is constantly varying. For example at phoneme boundaries, these changes can even become quite large. In that case, the perceived pitch can become quite different from the intended pitch if one uses the conventional source-filter method. This can lead to several perceived distortions in the synthesized signal, such as roughness and pitch jitter.

An illustration is given in FIG. 3, where the perceived pitch period is already constant and equal to P1′=P2′=P3′, while the pitch marks at zero crossings are such that P1>P2 and P2<P3 due to the changing waveform. When using the conventional method for generating a signal with constant pitch, equal to P1′ for example, the waveforms will be shifted relative to one another by P1′−P1, P2′−P2, and P3′−P3, respectively. This will lead to a perceived pitch that varies approximately according to 2P1′−P1, 2P2′−P2, and 2P3′−P3 which in turn will lead to perceived distortions of the desired pitch pattern P1′, P2′, P3′.

Such distortions have been observed before in the context of overlap-add synthesis techniques. Their origin has usually been associated with the fact that pitch mark positions can vary from period to period due to the influence of noise, DC-offset, phoneme transitions, etc. A method disclosed in document EP-A-0703565 proposes to solve the problem by choosing pitch marks at instants that are more robust than the zero crossing positions or the waveform maxima. In particular, the glottal closure instants are proposed in EP-A-0703565. While glottal closure instants are more robust than zero crossing positions for instance, they cannot provide a complete and effective solution to the problem for the obvious reason that the perceived pitch period will only correspond to the time delay between glottal closure instants if the filter impulse response is time invariant. Moreover, glottal closure instants are difficult to analyze and are not always well defined. For example, in certain mellow or breathy voice types that have a pitch percept associated to it, the vocal cords do not necessarily close once a period. In those cases, there is strictly speaking no glottal closure.

Patent document U.S. Pat. No. 5,966,687 relates to a vocal pitch corrector for use in a ‘karaoke’ device. The system operates based on two received signals, namely a human vocal signal at a first input and a reference signal having the correct pitch at a second input. The pitch of the human vocal signal is then corrected by shifting the pitch of the human vocal signal to match the pitch of the reference signal using appropriate circuitry. The pitch shifter circuit in this application therefore needs to modify the human vocal signal such that it will have a desired perceived pitch P″. The prior pitch shifter circuits, as explained above, could lead to a distorted pitch pattern that is perceived as P′, different from the intended P″.

### SUMMARY OF CERTAIN INVENTIVE EMBODIMENTS

A method and system is described for synthesizing various kinds of audio signals with improved pitch perception, thereby overcoming the drawbacks of the prior solutions.

In one embodiment, there is a method for synthesizing an audio signal with desired perceived pitch P″, comprising determining a train of pulses with relative spacing P and impulse responses h seen by the train of pulses, yielding an audio signal with actual perceived pitch P′; determining information related to the difference between the desired perceived pitch P″ and the actual perceived pitch P′; and correcting the audio signal for the difference between P″ and P′, thereby making use of the information, yielding the audio signal with desired perceived pitch P″.

The method can also be applied to audio equivalent signals, e.g., an electric signal that when applied to an amplifier and loudspeaker, yields an audio (audible) signal, or a digital signal representing an audio signal.

In an advantageous embodiment the impulse responses h are time-varying. Alternatively they can be all identical and invariable.

Preferably the determining information comprises determining the difference P″-P′. This difference is advantageously determined by estimating the actual perceived pitch P′. Alternatively, the difference can be determined via the cross correlation function between two output signals (e.g., impulse responses) corresponding to two consecutive impulses.

In a preferred embodiment the correcting comprises applying a train of pulses with spacing P″+P-P′.

In an alternative embodiment the determining information comprises determining a delay to give to the impulse responses h relative to their original positions. Advantageously the correcting is then performed by delaying the impulse responses with the delay.

In a typical embodiment, the audio signal is a speech signal.

In a specific embodiment, the method as described before is performed in an iterative way.

The method relates to a synthesis method based on the PSOLA strategy.

In another embodiment, there is a computer usable medium having computer readable program code comprising instructions embodied therein, executable on a programmable device, which when executed, performs the method as described above.

In yet another embodiment, there is an apparatus for synthesizing an audio signal with a desired perceived pitch P″, that carries out the method as described above.

### BRIEF DESCRIPTION OF THE DRAWINGS

FIG. 1 represents a pitch-excited source filter synthesis system.

FIG. 2 represents the construction of a voice source signal as an impulse train.

FIG. 3 represents perceived distortions in a synthesized speech signal.

FIG. 4 represents the pitch trigger concept with pseudo-period P and perceived pitch P′.

FIG. 5 represents a flow chart of OLA sound modification illustrating differences over the traditional methods.

FIG. 6 represents speech test waveform and pitch marks (circles) corresponding to glottal closure instants.

FIG. 7 represents two example implementations of the method.

FIG. 8 represents the operation of the example implementation. The top two panels show prev_h and h and their clipped versions (dashed), the bottom two panels the correlation between dashed curves (=XC(n)) and corrected impulse response h.

FIG. 9 represents results showing original signal and corrected version with a perceived pitch of 109 Hz (101 samples at 11025 Hz sampling frequency).

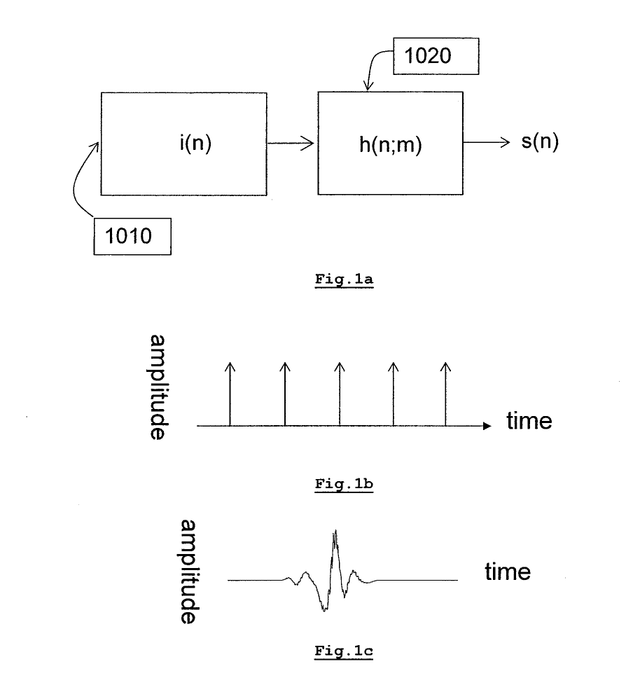

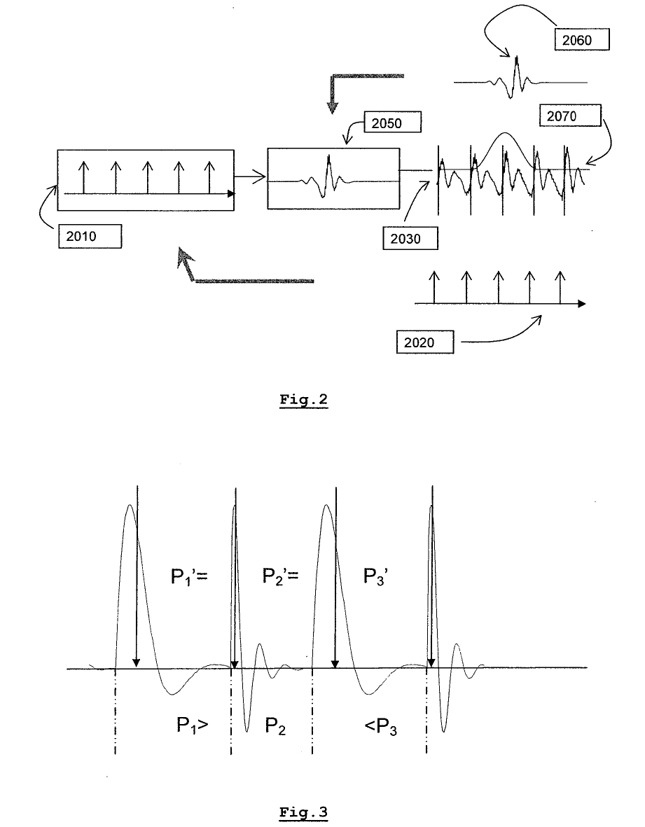

### DETAILED DESCRIPTION OF CERTAIN EMBODIMENTS

The following detailed description of certain embodiments presents various descriptions of specific embodiments of the invention. However, the invention can be embodied in a multitude of different ways as defined and covered by the claims. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

It was observed that the perceived pitch does not depend on any isolated event in the pitch periods, but on the details of the entire neighboring speech waveform. Therefore, the present system and method proposes to use one or more pitch estimation methods for deciding at what time delay the consecutive impulse responses are to be added in order to ensure that the synthesised signal will have a perceived pitch equal to the desired one.

In one embodiment, a pitch detection method is used to estimate the pitch P′ that will be perceived if consecutive impulse responses are added with a relative spacing P (FIG. 4). If the desired perceived pitch is P″, the spacing between impulse responses (and hence between the corresponding impulses of i(n)) will be chosen as P″-P′+P. For estimating the perceived pitch, any pitch detection method can be used (examples of known pitch detection methods can be found in W. Hess, Pitch Determination in Speech Signals, Springer Verlag). Obviously, if so desired, the functionality of pitch estimation, such as the autocorrelation function or the average magnitude difference function (AMDF) can be integrated in the synthesiser itself. For example, the cross correlation between two consecutive impulse responses can be computed, and the local maximum of this cross correlation can be taken as an indication of the difference that will exist between the perceived pitch and the spacing between the corresponding pulses in the voice source. In that case, the system and method can be materialized by decreasing the spacing between pulses by that same difference.

In another embodiment of the system and method, instead of adjusting the spacing between input pulses, the impulse responses h(n, m) are delayed by a positive or negative time interval relative to their original position. The resulting impulse responses h″(n;m) can then be used with the original spacing P between impulses. In the above mentioned illustrative example, one possible way of achieving this is by letting h″(n;m)=h(n;m) and h″(n;m+P)=h(n−T;m+P) where T=P″−P′.

In yet another embodiment, both the spacing between source pulses and the delay of the impulse responses can be adjusted in any desired combination, as long as the combined effect ensures an effective distance between overlapped segments of P″−P′+P.

In addition, the system and method provides for a mechanism for improving even further the precision with which a desired perceived pitch can be realized. This method proceeds iteratively and first starts by constructing a speech signal according to one of the methods that are described above or any other synthesis method, including the conventional ones. Following this, the perceived pitch of the constructed signal is estimated, and either the pulse locations or the impulse response delays are adjusted as described above and a new approximation is synthesized. The perceived pitch of this new signal is also estimated and the synthesis parameters are again adjusted to compensate for possibly remaining differences between the perceived pitch and the desired pitch. The iteration can go on until the difference is below a threshold value or until any other stopping criterion is met. Such small difference can for example exist as a result of the overlap between successive repositioned impulse responses. Indeed, because of this, the detailed appearance of the speech waveform can change from one iteration to the next and this can in turn influence the perceived pitch. The system and method provides for a means for compensating for this effect, the iterative approach being a preferred embodiment for doing so.

### EXAMPLES

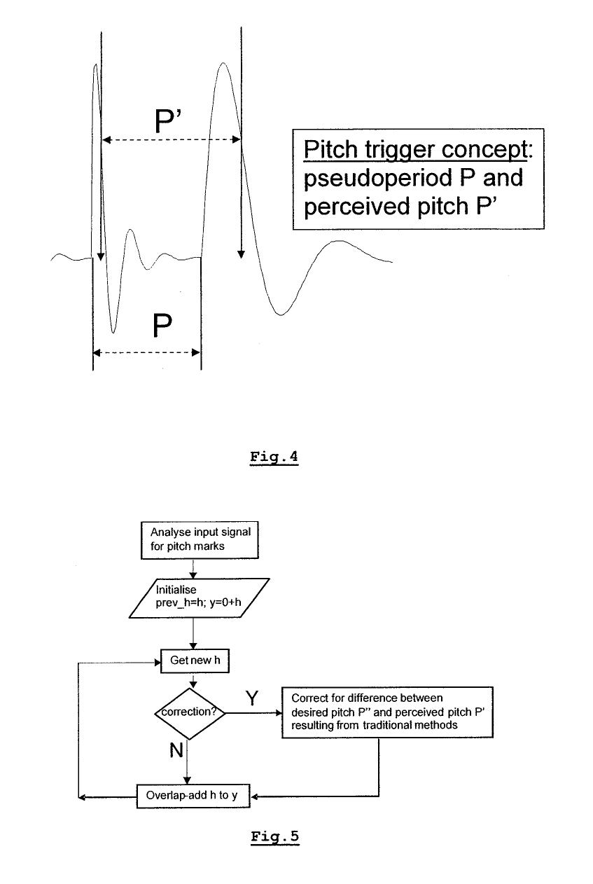

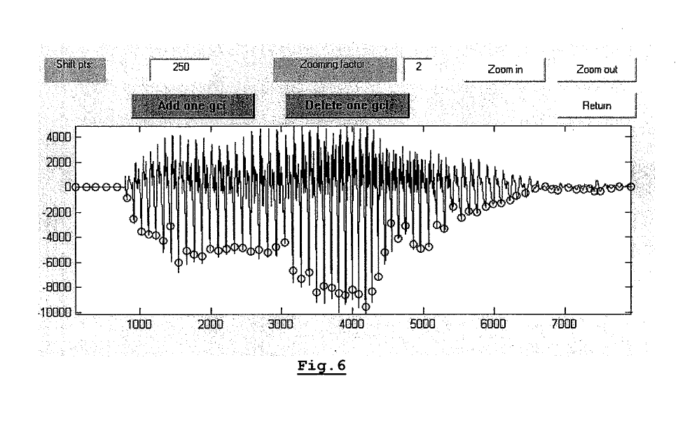

FIG. 5 illustrates a general flow chart that can be used for implementing different versions of Overlap-Add (OLA) sound modification. As illustrated, the input signal is first analysed to obtain a sequence of pitch marks. The distance P between consecutive pitch marks is time-varying in general. Depending on the specific OLA technique used, these pitch marks can be located at zero crossings at the beginning of each signal period or at the signal maxima in each period, etc. By choosing to perform the correction act, the method is performed.

In the implementation examples that follow, the pitch marks were chosen to be positioned at the instants of glottal closure. These were determined with a program that is available from Speech Processing and Synthesis Toolboxes, D. G. Childers, ed. Wiley & Sons. The result for an example input file is illustrated in FIG. 6, where open circles indicate the instants of glottal closure. The impulse response h at a certain pitch mark is typically taken to be a weighed version of the input signal that extends from the preceding pitch mark to the following pitch mark.

For pitch modification the OLA methods add successive impulse responses to the output signal at time instances that are given by the desired pitch contour (in unvoiced portions the pitch period is often defined as some average value, e.g., 10 ms). In the conventional method the separation between successive impulse responses in the synthesis operation is equal to the desired pitch P″. However, because of the time varying nature of the impulse response shape, the perceived pitch P′ can be different from the intended pitch P″. The solution proposes a method to compensate for this difference.

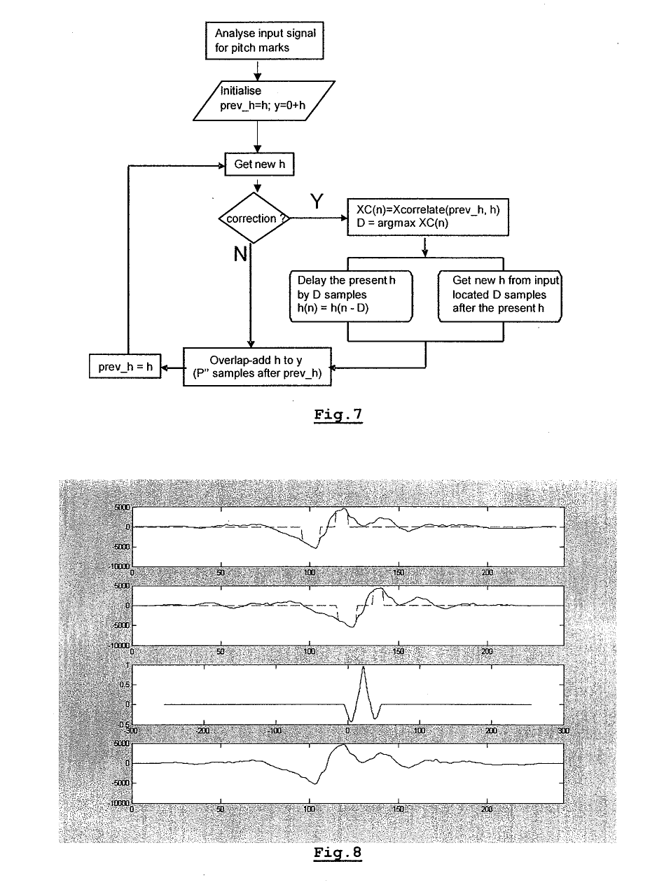

Two example instances of the present method have been implemented in software (e.g., Matlab). The synthesis operation consists of overlap-adding impulse responses h to the output. The correction that is needed is determined in both instances using an estimate of the difference between the pitch P′ that would be perceived and the time distances P that would separate successive impulse responses in the output. In both example implementations, an estimate of this difference P′−P is computed from a perceptually relevant correlation function between the previous impulse response and the current impulse response. An impulse response will then be added P″ after the previous impulse response location, like in the traditional OLA methods, but the difference between the perceived pitch period and the distances between impulse responses will be compensated for by modifying the current impulse response before addition in both these examples (see FIG. 7). As explained before, alternative embodiments could modify the distance between impulse responses and/or the impulse response itself to achieve the same desired precise control over the perceived pitch.

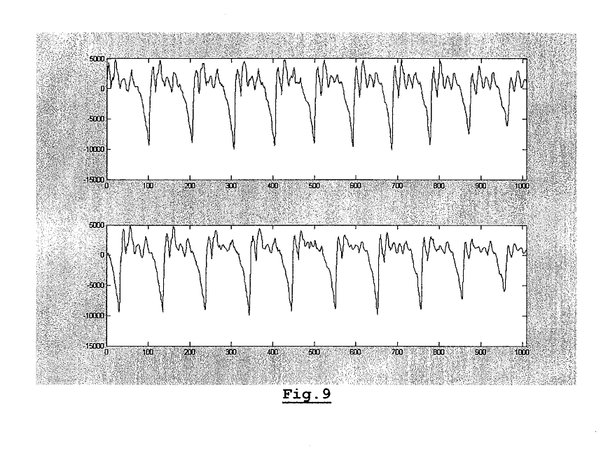

The first three panels of FIG. 8 illustrate the operation of obtaining an estimate of P′−P that was implemented in both of the example implementations. The impulse response that was previously added to the output (prev_h in FIG. 7) is shown in solid line in the first panel and the current impulse response h is shown in solid in the second panel. In dashed line in these panels are the clipped versions of these impulse responses (a clipping level of 0.66*max(abs(impulse response)) was used in the example). The third panel shows the normalised cross-correlation between the two dashed curves. This cross-correlation attains a maximum at time index 21, indicating that the parts of the two impulse responses that are most important for pitch perception (many pitch detectors use the mechanism of clipping and correlation) become maximally similar if the previous response is delayed by 21 samples relative to the current response. This is a fact that is neglected in the traditional methods and it is characteristic of the disclosed method to take this fact into account.

As illustrated in FIG. 7, two different ways of doing so were implemented. The first one is the most straightforward one and consists of adding the current impulse response P″−21 samples after the previous one, instead of P″ as in the traditional methods (recall that P″ is the desired perceived pitch period).

In an alternative method, the quasi periodicity of pitch-inducing waveforms is exploited. Instead of using the current impulse response, a new impulse response from the input signal is analysed at a position located 21 samples after the position where the current response from panel 2 was located. This new impulse response is illustrated in the last panel of FIG. 8. As one can see, it has a better resemblance and is better aligned with the previous impulse response than the one in panel 2 that is used in the traditional methods.

Another interesting alternative would be to use the previous impulse response (panel one) directly in a search procedure that would search the input signal for an impulse response that is perceptually maximally similar to the previous one and that is located in the neighbourhood of the traditional position for the current impulse response. Such a similarity criterion was already used successfully for segment alignment in the Waveform Similarity based overlap-add (WSOLA) time-scaling algorithm, but it was not yet applied for impulse response correction in high precision pitch modification algorithms.

In the above, one has concentrated on voiced speech portions. In the current example applications, it was decided that the current segment is unvoiced if the maximum of the cross-correlation function in panel 3 is less than a threshold value (such as 0.5 for example). In that case one can choose to either follow the same procedure as in the voiced case (the approach according to the present method) or to follow the traditional method and apply no correction to the current impulse response in unvoiced regions. While the first option could be exploited to achieve robustness against voiced/unvoiced decision errors, the second option would result in unvoiced speech portions being copied to the output without modification (and hence without audible differences).

### CONCLUSION

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the intent of the invention. The scope of the invention is indicated by the appended claims rather than by the foregoing description. All changes which come within the meaning and range of equivalency of the claims are to be embraced within their scope.

What is claimed is:

1. A method for synthesizing an audio signal with a desired perceived pitch P″, comprising:
determining a train of pulses with relative spacing P and impulse responses h seen by the train of pulses, yielding an audio signal with actual perceived pitch P′;
determining information related to the difference between the desired perceived pitch P″ and the actual perceived pitch P′; and
correcting the audio signal for the difference between P″ and P′, thereby making use of the information, yielding the audio signal with desired perceived pitch P″.

2. The method as in claim 1, wherein the impulse responses h are time-varying.

3. The method as in claim 1, wherein the impulse responses h are invariable.

4. The method as in claim 1, wherein the determining information comprises determining the difference P″−P′.

5. The method as in claim 4, wherein the difference is determined by estimating the pitch P′.

6. The method as in claim 4, wherein the difference is determined via the cross correlation function between two output signals corresponding to two consecutive impulses.

7. The method as in claim 4, wherein the correcting comprises applying a train of pulses with spacing P″+P−P′.

8. The method as in claim 1, wherein the determining information comprises determining a delay to give to the impulse responses h relative to their original positions.

9. The method as in claim 8, wherein the correcting is performed by delaying the impulse responses with the delay.

10. The method as in claim 1 wherein the audio signal is a speech signal.

11. A method for obtaining an audio signal with a desired perceived pitch P″, wherein the method is performed in an iterative way:
determining a train of pulses with relative spacing P and impulse responses h seen by the train of pulses, yielding an audio signal with actual perceived pitch P′;
determining information related to the difference between the desired perceived pitch P″ and the actual perceived pitch P′; and
correcting the audio signal for the difference between P″ and P′, thereby making use of the information, yielding the audio signal with desired perceived pitch P″.

12. A synthesis method based on the pitch synchronized overlap-add (PSOLA) strategy, the method comprising:
determining a train of pulses with relative spacing P and impulse responses h seen by the train of pulses, yielding an audio signal with actual perceived pitch P′;
determining information related to the difference between the desired perceived pitch P″ and the actual perceived pitch P′; and
correcting the audio signal for the difference between P″ and P′, thereby making use of the information, yielding the audio signal with desired perceived pitch P″.

13. A computer usable medium having computer readable program code comprising instructions embodied therein, executable on a programmable device, which when executed, performs the method as in claim 1.

14. An apparatus for synthesizing an audio signal with desired perceived pitch P″, that carries out the method as in claim 1.
